(19) United States
(12) Patent Application Publication
(10) Pub. No.: US 2025/0378115 A1
(43) Pub. Date: Dec. 11, 2025

(54) MODELING GRAPHS ON DISTRIBUTED STORAGE

(71) Applicant: GRANT HAYWOOD, TIERJAS, NM (US)

(72) Inventor: GRANT HAYWOOD, TIERJAS, NM (US)

(21) Appl. No.: 19/080,943

(22) Filed: Mar. 17, 2025

Related U.S. Application Data
(63) Continuation-in-part of application No. 19/011,499, filed on Jan. 6, 2025.
(60) Provisional application No. 63/606,096, filed on Dec. 5, 2023.
(60) Provisional application No. 63/623,333, filed on Jan. 21, 2024.

(51) Int. Cl. G06F 16/901; G06F 16/27

(52) U.S. Cl. CPC G06F 16/9024; G06F 16/27

(57) ABSTRACT

In one aspect, a method for modeling graphs on distributed storage, comprising: receiving graph data including vertices, edges, and properties; mapping each vertex to a vertex record in a distributed storage system; mapping each edge to an edge record in the distributed storage system; mapping each property to a property record in the distributed storage system; determining, for each vertex, whether a number of incident edges exceeds a maximum record size threshold; storing pointers to incident edge records directly within vertex records when the number of incident edges does not exceed the maximum record size threshold; utilizing an adjacency index to lookup incident edge records when the number of incident edges exceeds the maximum record size threshold; and executing graph traversal operations that navigate from vertex to vertex by accessing the appropriate edge records through either the stored pointers or the adjacency index.

### CLAIM OF PRIORITY

This application claims priority to and is a continuation in part of United States Patent application no. filed on Jan. 6, 2025. This application is hereby incorporated by reference in its entirety.

U.S. patent application Ser. No. 19/011,499 claims priority to U.S. Provisional Application 63/623,333 filed on Jan. 21, 2024. This application is hereby incorporated by reference in its entirety.

U.S. patent application Ser. No. 19/011,499 claims priority to U.S. Provisional Application 63/606,096 filed on Dec. 5, 2023. This application is hereby incorporated by reference in its entirety.

### BACKGROUND

Graph databases and distributed storage systems have become increasingly important for managing complex, interconnected data across various applications and industries. Traditional relational database management systems (RDBMS) are designed around a tabular data model with rigid schemas that can struggle to efficiently represent highly connected data. This limitation becomes particularly apparent when attempting to model real-world relationships that form natural graph structures.

The fundamental unit of a graph database is the vertex (or node), which represents an entity, and edges (or links), which represent the relationships between these entities. While this basic structure is powerful, modern applications often require additional contextual information attached to these elements, leading to the development of property graphs. Property graphs extend the core graph concept by allowing key-value metadata to be associated with both vertices and edges, providing richer semantic context.

Existing approaches to implementing graph databases often face significant challenges when dealing with distributed storage environments. Many implementations rely on specialized storage engines that are optimized for graph traversal but lack the scalability advantages of modern distributed storage systems. Conversely, attempts to build graph databases on top of distributed key-value stores or record-oriented databases often sacrifice performance or flexibility.

A particular challenge arises when mapping graph elements to distributed storage records. Vertices in a graph may have an unbounded number of connected edges, potentially exceeding the maximum size constraints of individual storage records in distributed systems. This limitation forces implementers to choose between compromising on the graph model's expressiveness or accepting significant performance penalties.

Current solutions typically address this through complex indexing schemes or by limiting the functionality of the graph model. For example, some systems maintain separate indices for edge lookups, requiring additional I/O operations during traversals. Others may impose artificial constraints on vertex degree or edge properties, limiting their applicability to real-world problems.

Furthermore, the execution model for graph queries introduces additional complexity. The traversal pattern, commonly used in graph query languages like Gremlin, requires efficient access to adjacent elements as execution pointers move through the graph. When these elements are distributed across a network of storage nodes, each traversal step can introduce substantial latency, severely impacting query performance.

Caching and locality optimization strategies have been employed to mitigate these issues, but existing approaches often make static decisions about data layout that cannot adapt to the diverse access patterns of different applications and queries. This results in systems that may perform well for specific workloads but struggle to maintain consistent performance across varied use cases.

There is therefore a need for a more flexible and efficient approach to modeling graphs on distributed storage systems that can overcome the inherent tensions between the unbounded connectivity of graph data models and the practical constraints of distributed storage infrastructure, while maintaining the performance characteristics necessary for complex graph traversals and queries.

### SUMMARY OF THE INVENTION

In one aspect, a method for modeling graphs on distributed storage, comprising: receiving graph data including vertices, edges, and properties; mapping each vertex to a vertex record in a distributed storage system; mapping each edge to an edge record in the distributed storage system; mapping each property to a property record in the distributed storage system; determining, for each vertex, whether a number of incident edges exceeds a maximum record size threshold; storing pointers to incident edge records directly within vertex records when the number of incident edges does not exceed the maximum record size threshold; utilizing an adjacency index to lookup incident edge records when the number of incident edges exceeds the maximum record size threshold; and executing graph traversal operations that navigate from vertex to vertex by accessing the appropriate edge records through either the stored pointers or the adjacency index.

### BRIEF DESCRIPTION OF THE DRAWINGS

FIG. 1 illustrates an example process for modeling graphs on distributed storage, according to some embodiments.

FIG. 2 illustrates an example process for modeling graphs on distributed storage, according to some embodiments.

FIG. 3 illustrates an example process for implementing a OpenSource TinkerPop Java library to use its implementation of a Traversal model to execute queries, according to some embodiments.

FIG. 4 illustrates an example process for gaining leverage over data, according to some embodiments.

FIG. 5 illustrates an example concrete graph traversal implementation, according to some embodiments.

FIG. 6 illustrates an example process for modeling graphs on distributed storage, according to some embodiments.

The Figures described above are a representative set and are not exhaustive with respect to embodying the invention.

### DESCRIPTION

Disclosed are a system, method, and article of manufacture for modeling graphs on distributed storage, according to some embodiments.

The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Database schema is the structure of a database described in a formal language (e.g. supported by a relational database management system (RDBMS)). Schema refers to the organization of data as a blueprint of how the database is constructed (e.g. divided into database tables in the case of relational databases). A database schema can be a set of formulas (e.g. sentences) called integrity constraints imposed on a database. These integrity constraints ensure compatibility between parts of the schema.

Graph is an abstract data type that is meant to implement the undirected graph and directed graph concepts from the field of graph theory within mathematics. A graph data structure consists of a finite set of vertices (e.g. nodes, points, etc.), together with a set of unordered pairs of these vertices for an undirected graph or a set of ordered pairs for a directed graph. These pairs are known as edges (e.g. links, lines, etc.), and for a directed graph are also known as edges but also sometimes arrows or arcs. The vertices may be part of the graph structure or may be external entities represented by integer indices or references. A graph data structure may also associate to each edge some edge value, such as a symbolic label or a numeric attribute (e.g. cost, capacity, length, etc.).

Property graph can provide relationships that are connections and a name (e.g. type). Other properties can be included. A property graph can be used for connections for data in various Data Architectures and/or data schemas. A property graph can include/show the relationships between metadata as well. Property graphs also show data dependencies as well.

TinkerPop is an open-source graph computing framework that provides a collection of technologies that help developers build graph-based applications. It serves as a vendor-agnostic connectivity layer between graph databases and graph processing systems, allowing applications to work with multiple graph technologies through a common interface. TinkerPop's most notable component is Gremlin, a graph traversal language and virtual machine that enables users to write complex queries to navigate and manipulate graph data. The framework also includes tools for graph analytics, visualization, and integration with various programming languages. By abstracting the underlying implementation details, TinkerPop allows developers to build applications that can work across different graph databases without needing to rewrite code, effectively creating a standard for graph data processing that is been adopted by many major graph database providers.

Vertex (e.g. node) can be the fundamental unit of which graphs are formed.

### Example Methods

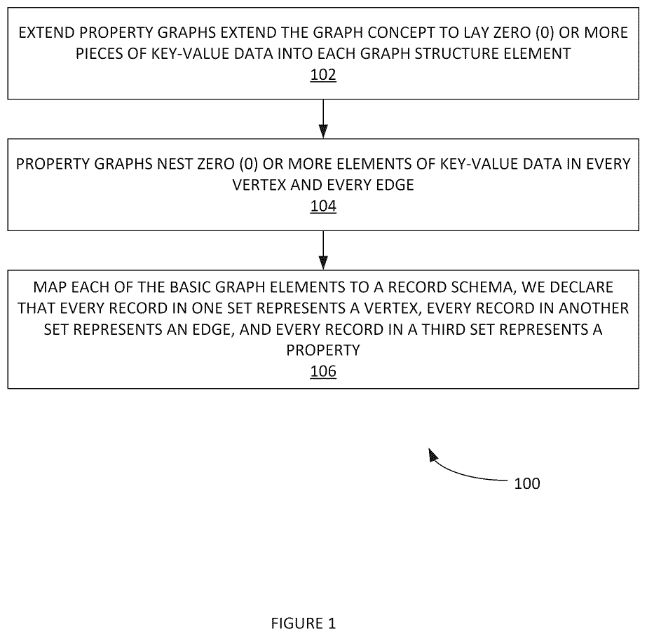

FIG. 1 illustrates an example process for modeling graphs on distributed storage, according to some embodiments. It is noted that graph elements can be “thin” in the sense of how much information each individual element carries. This is somewhat offset when graphs are extended into property graphs.

In step 102, process 100 extends property graphs extend the graph concept to lay zero (0) or more pieces of key-value data into each graph structure element. In the base case, no additional information is added per element (e.g. zero (0) properties). In the limit case, an unbounded number of Properties are added to each Graph Element, with some unbounded key size and unbounded value size.

In the practical business use case, in step 104, the number and size of properties laid on top of each Graph Element is likely to be a small value. For example, when there is a predefined key-record structure. Process 100 can encode the general case of graphs on top of the predefined key-record structure.

A vertex is one type of record, an edge is another type of record. In step 104, property graphs nest zero (0) or more elements of key-value data in every vertex and every edge. For example, properties (e.g. key-value pairs inside the graph) are another type of record. In this example, there can be three (3) groups, or sets, of record type.

In step 106, process 100 can map each of the basic graph elements to a record schema, we declare that every record in one set represents a vertex, every record in another set represents an edge, and every record in a third set represents a property. These can be, inter alia: the vertex set, the edge set, and the property set. A vertex record can contain pointers (e.g. keys) to the edge records that are incident to it. An edge record can encode pointers (e.g. keys) to both the vertices used to construct it. Both edge and vertex records can have pointers (keys) to any property records belonging to them. In this way we have a standard way of mapping every elementary graph component to one of three (3) standard types (e.g. schemas, layouts) of record.

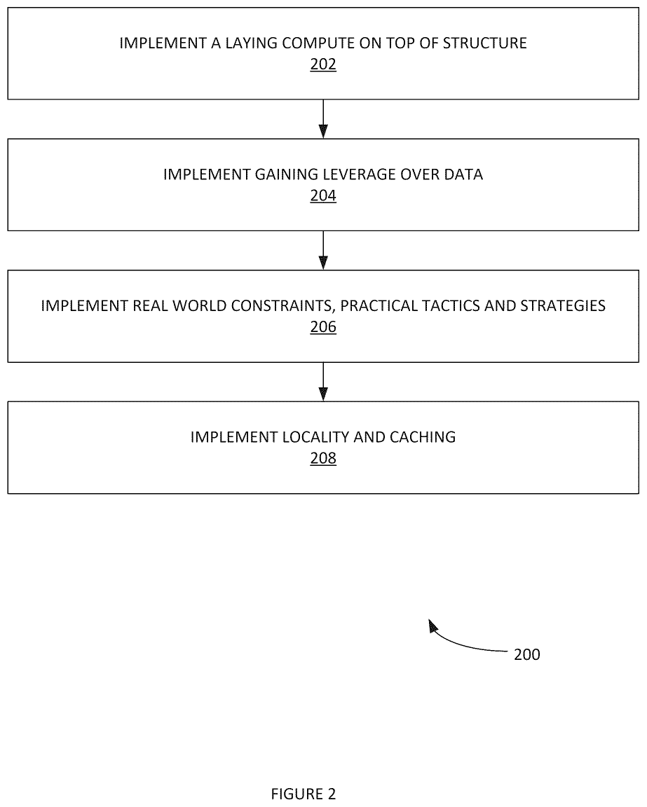

FIG. 2 illustrates an example process 200 for modeling graphs on distributed storage, according to some embodiments.

In step 202, process 200 implements a laying compute on top of structure. In one example process 200 can model query execution over graph structured data is the traversal pattern.

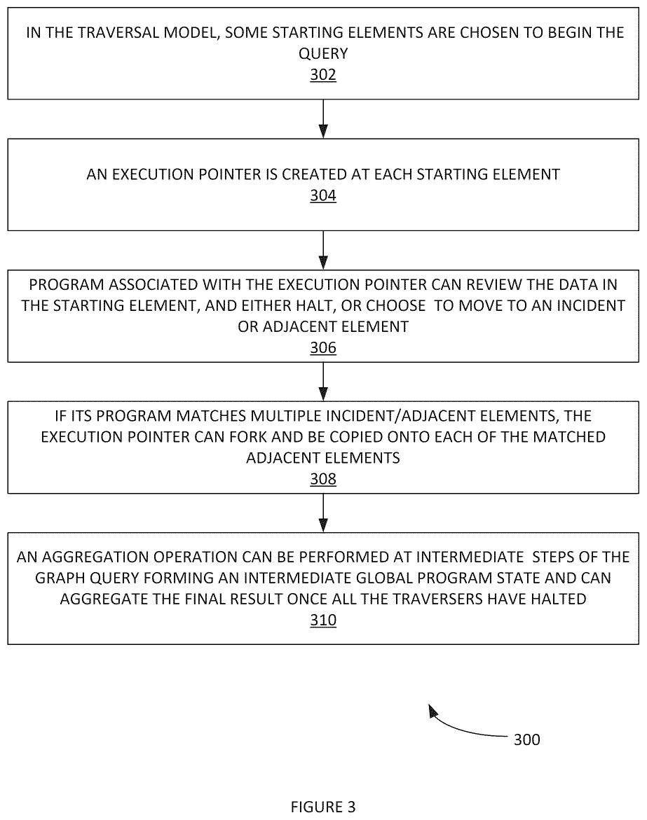

FIG. 3 illustrates an example process 300 for implementing a the OpenSource TinkerPop Java library to use its implementation of a Traversal model to execute queries, according to some embodiments. The present invention is for mapping a Graph onto distributed storage. Some starting elements (typically vertices or edges, perhaps properties) are chosen to begin the query in step 302. In step 304, an execution pointer (e.g. traverser) is created at each starting element. The program associated with the execution pointer can review the data in the starting element, and either halt, or choose to move (e.g. traverse) to an incident or adjacent element in step 306. If its program matches multiple incident/adjacent elements, the execution pointer can fork and be copied onto each of the matched adjacent elements in step 308. Each traverser can carry some local program state as they move, split, and visit the elements matched by their encoded traversal program. The aggregation of these local traverser program states is the global program state of the graph query. An aggregation operation can be performed at intermediate (e.g. barrier) steps of the Graph Query forming an intermediate global program state and can aggregate the final result once all the traversers have halted (e.g. query answer) in step 310.

In step 204, process 200 implements gaining leverage over data.

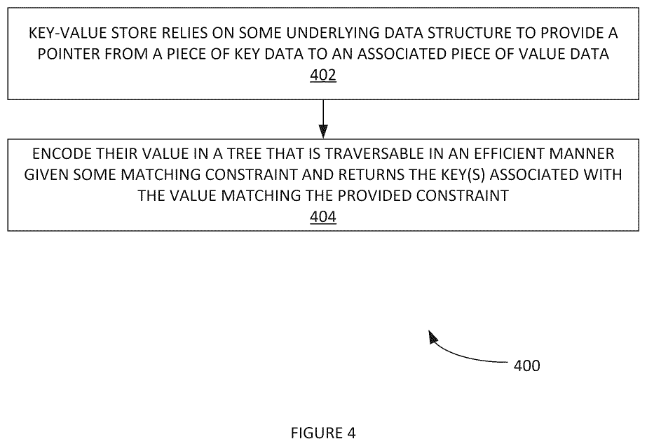

FIG. 4 illustrates an example process 400 for gaining leverage over data, according to some embodiments. The key-value store can rely on some underlying data structure to provide a pointer from a piece of key data to an associated piece of value data in step 402. Practical database systems gain additional leverage by building additional (e.g. secondary) indices over whole or sub-components of the value data associated with each key. This is done by encoding their value in a tree that is traversable in an efficient manner given some matching constraint and returns the key(s) associated with the value matching the provided constraint (e.g. query) in step 404. This is a type of reverse lookup.

In step 206, process 200 implements real world constraints, practical tactics and strategies. In the real-world practical implementations of key-value or key-record systems have implementation constraints. There can be a constant overhead in terms of memory (e.g. space) and processing (e.g. time) complexity to create, lookup and delete a Record.

There may be a limit to the size of key or record data available in any individual database entry. The definition of a vertex does not limit the number of edges that can be associated with it. Each edge ID may require storage space. Encoding a pointer to every incident Edge Record takes NE*K space, where NE is the number of edges incident to the Vertex in question, and K is the physical storage size of an edge id. If NE*K>maximum Record size, we have a problem. Process 200 can address this practical issue while still allowing the flexibility to support the general case of Graph. If every edge has its two (2) associated vertex ids encoded, an index can be built to lookup from vertex id to edge IDs. It is always practical for an edge to encode its vertex keys because there are only ever two (2). It is not always practical for a vertex to encode all its incident Edge keys, because they are unbounded in number.

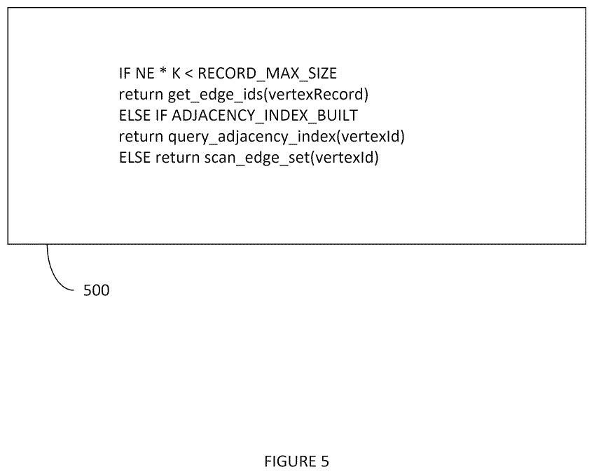

In one case, when the vertex degree is larger than our physical storage unit, process 200 can use an index over the vertex IDs in the edge table. In the worst case, we need to perform a brute-force search (e.g. scan) to match edges that encode the vertex id in question (e.g. reverse lookup). Practically speaking, as a traverser moves from vertex to vertex, it is much faster to have the edge keys “in hand” as the execution pointer visits them, then to have to context switch into an index lookup every time we want to know “who is next door?”. For this reason process 200 can use tactics (e.g. strategies) in a concrete graph traversal implementation. FIG. 5 illustrates an example concrete graph traversal implementation 500, according to some embodiments.

IF NE*K<RECORD_MAX_SIZE

return get_edge_ids (vertexRecord)

ELSE IF ADJACENCY_INDEX_BUILT

return query_adjacency_index (vertexId)

ELSE return scan_edge_set (vertexId)

An alternative pattern is a “tree structured” record. In this pattern, there is a primary record, and N leaf records. Process 200 can reserve a segment of space in the primary record to store pointers to “leaf” records. If leaf pointers are present in the record, it indicates that we need to go read all the leaf records into memory to have the complete view of the primary record.

A concrete implementation is now discussed. Process 200 can perform a concrete implementation of Graph to Record mapping on the JVM, leveraging the TinkerPop graph traversal runtime and Gremlin query language. This graph mapping and query system does I/O to a distributed storage engine across a standard TCP/IP network.

In step 208, process 200 can implement locality and caching. Process 200 can provide a clean layout of each of the graph components. Physically however, mapping each atomic unit of the graph onto the physical storage unit available may not be performant. In this configuration, the minimum number of individual reads required to execute a query program is equivalent to the number of graph components touched. This is not “bad” in the sense that it has linear runtime complexity O(1).

Implementation techniques are now discussed. A combination of “packing” and caching means that in many realistic environments we can achieve a sub-linier number of read operations compared to the number of atomic graph components being worked with. Packing as the collocation of one element with either its “parent” element, or together with a group of like elements. At implementation time, process 200 can pack the property key-value pairs onto their edge or vertex, in order to give them locality with their parent vertex or edge, the most likely location they will be accessed from. Process 200 can also pack partial edge information into the vertices to the extent room is available in the native storage unit. Several layers of caching were employed to both avoid re-reads of data during the execution of an individual query program and to avoid reading incident edge data when possible. When appropriate, batch operations against the backing storage engine are used to grab groups of elements that are required to solve the query program, in order to reduce the buildup of round trip I/O latency with the backing storage engine.

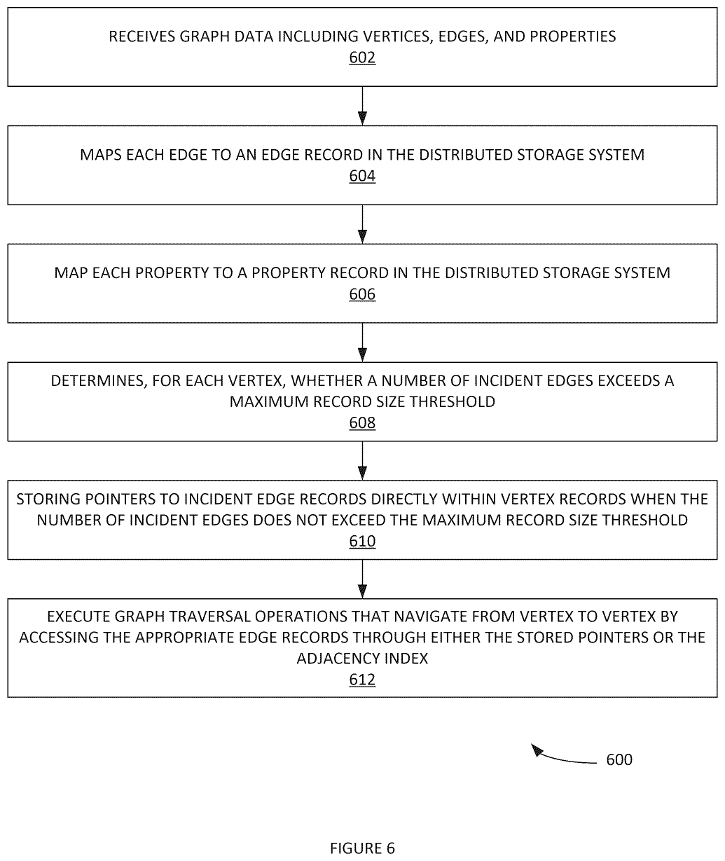

FIG. 6 illustrates an example process 600 for modeling graphs on distributed storage, according to some embodiments. In step 602, process 600 receives graph data including vertices, edges, and properties. In step 604, process 600 maps each vertex to a vertex record in a distributed storage system. In step 606, process 600 maps each edge to an edge record in the distributed storage system. Process 600 can also map each property to a property record in the distributed storage system. In step 608, process 600 determines, for each vertex, whether a number of incident edges exceeds a maximum record size threshold; storing pointers to incident edge records directly within vertex records when the number of incident edges does not exceed the maximum record size threshold. In step 610, process 600 utilizes an adjacency index to look up incident edge records when the number of incident edges exceeds the maximum record size threshold. In step 612, process 600 executes graph traversal operations that navigate from vertex to vertex by accessing the appropriate edge records through either the stored pointers or the adjacency index.

The Graph Database System Implementation for Distributed Storage is designed as a comprehensive solution to efficiently manage graph data across distributed storage environments. The architecture consists of interconnected components that work harmoniously to address the unique challenges of graph storage and traversal.

At its core, the Data Ingestion and Mapping Layer receives graph data from various sources including APIs, file imports, and streaming inputs, parsing and validating vertex, edge, and property structures before mapping each graph element to appropriate record types in the distributed storage system. The Record Schema Manager defines the schema for vertex, edge, and property records while maintaining the mapping between graph elements and storage records, ensuring referential integrity through pointer management and tracking metadata about record sizes and relationships.

The Edge Management System implements the adaptive edge storage strategy, determining the appropriate storage method based on vertex degree, containing direct pointer storage for low-degree vertices, and managing adjacency indices for high-degree vertices. Working alongside these components, the Traversal Engine executes graph queries using traversal patterns, creating and managing execution pointers (traversers), implementing forking logic for multiple paths, aggregating results from traversal operations, and maintaining compatibility (e.g. with TinkerPop and Gremlin interfaces, by way of example).

The Storage Interface Layer abstracts the underlying distributed storage system, handling CRUD operations on records, implementing batch operations for related elements, and managing connection pools to storage nodes. To optimize performance, the Multi-level Cache Manager caches frequently accessed vertices and edges, implements locality-aware caching policies, maintains cache coherence across the distributed environment, and provides configurable cache sizing and eviction strategies. Finally, the Performance Optimization Engine implements packing strategies for properties and partial edges, manages tree-structured records for high-degree vertices, optimizes read patterns based on query analysis, and dynamically selects between direct access, index lookup, and scanning methods.

The system can be implemented using Java for TinkerPop (e.g. by way of example) compatibility, with configurable storage backends including, by way of example, inter alia: Apache Cassandra, Amazon DynamoDB, Redis Cluster, or custom distributed key-value stores, alongside Gremlin API (e.g. by way of example) implementation, off-heap memory management with configurable eviction policies, B-tree or LSM-tree based adjacency indices, and gRPC for efficient distributed communication. During operation, when graph data is received, the system maps each element to the appropriate record type, calculates the space required for edge pointers for each vertex and compares it with the maximum record size, storing pointers directly when they fit within the vertex record or creating entries in an adjacency index when they exceed the maximum size.

When executing traversals, the system creates execution pointers at starting elements, navigates through the graph, determines the appropriate method to access edge information, utilizes the multi-level cache to minimize storage access, employs batch operations for complex queries, and aggregates results as traversers complete their paths, providing a flexible, efficient implementation of graph databases on distributed storage systems while addressing the fundamental challenge of unbounded vertex connectivity through adaptive storage strategies.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A method for modeling graphs on distributed storage, comprising:
receiving graph data including vertices, edges, and properties;
mapping each vertex to a vertex record in a distributed storage system; mapping each edge to an edge record in the distributed storage system;
mapping each property to a property record in the distributed storage system;
determining, for each vertex, whether a number of incident edges exceeds a maximum record size threshold;
storing pointers to incident edge records directly within vertex records when the number of incident edges does not exceed the maximum record size threshold;
utilizing an adjacency index to look up incident edge records when the number of incident edges exceeds the maximum record size threshold; and
executing graph traversal operations that navigate from vertex to vertex by accessing the appropriate edge records through either the stored pointers or the adjacency index.

2. The method of claim 1, further comprising:
collocating property records with their associated vertex or edge records to improve data locality during traversal operations.

3. The method of claim 1, further comprising:
implementing a multi-level caching system to store frequently accessed vertex and edge records to reduce the number of read operations to the distributed storage system.

4. The method of claim 1, further comprising:
packing partial edge information into vertex records to the extent available space permits within the maximum record size threshold.

5. The method of claim 1, wherein executing graph traversal operations further comprises:
creating execution pointers at starting elements;
moving the execution pointers to adjacent elements based on traversal logic;
forking execution pointers when multiple adjacent elements match traversal criteria;
and aggregating results from multiple execution pointers to produce a final query result.

6. The method of claim 1, further comprising:
performing batch operations against the distributed storage system to retrieve groups of related elements required for query execution.

7. The method of claim 1, further comprising:
implementing a tree-structured record pattern for vertices with high edge counts, comprising a primary vertex record and multiple leaf records containing additional edge pointers.

8. The method of claim 1, wherein each edge record contains pointers to exactly two vertex records, and each vertex record contains pointers to zero or more edge records based on the maximum record size threshold.

9. The method of claim 1, wherein executing graph traversal operations includes utilizing a graph traversal runtime compatible with the TinkerPop framework and Gremlin query language.

10. The method of claim 1, further comprising:
dynamically selecting between direct pointer access, adjacency index lookup, or edge set scanning based on vertex degree and system configuration to optimize traversal performance.
